(19) United States
(12) Patent Application Publication
(10) Pub. No.: US 2007/0217353 A1
(43) Pub. Date: Sep. 20, 2007

(54) Method and Apparatus for Transmitting Data Within a Multi-Hop Communication System

(75) Inventors: Masahito Asa, Tokyo (JP); Ryutaro Hamasaki, Tokyo (JP); Mohsin Mollah, Chiba-Shi (JP)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,973

(22) Filed: Mar. 20, 2006

(51) Int. Cl. H04B 7/14; H04J 3/08; H04J 1/10; H04J 3/06; H04Q 7/00

(52) U.S. Cl. 370/315; 370/503; 370/328

(57) ABSTRACT

A method and apparatus for relaying data within a multi-hop communication system (200) is provided herein. During operation, all preamble (301, 305) and broadcast (303, 307) information for relaying nodes (201) and for the base station (204) is placed during a beginning portion (315) of a frame (300) prior to any data transmission (511, 609). By placing preamble/broadcast portions in the beginning of the frame, the data transmission portions of the frame can be allowed to vary in time, yet synchronization will be allowed between all nodes in the system.

### FIELD OF THE INVENTION

The present invention relates generally to data transmissions within communication systems and in particular, to a method and apparatus for transmitting data within a multi-hop communication system.

### BACKGROUND OF THE INVENTION

Next-generation communication systems, such as a communication system employing the IEEE 802.16 protocol, will need to efficiently relay data to enhance coverage reliability compared to existing point-to-multipoint systems. More particularly, when a node is out of communication range of a base station, data can be relayed to the node via other, intervening nodes. When such multi-hop functionality is introduced into the existing IEEE 802.16 communication system protocol, the existing frame will be divided into an incoming part and an outgoing part at the intervening node. If the incoming part and outgoing part are fixed in length, inefficiencies result. The boundary between incoming and outgoing at intervening node is decided by transmitting preamble and broadcast messages from the intervening node. If the boundary is varied by changing the timing of the transmitted preamble and broadcast messages from the intervening node, synchronization problems result in the receiving node. Because of this, the current frame structure is defined such that all relaying must take place in a predefined, non-varying area of the downlink frame. This results in an inefficient downlink transmission. FIG. 1 illustrates this problem in greater detail.

As shown in FIG. 1, portion 101 of frame 100 is used for downlink transmissions from a base station, while portion 102 of frame 100 is used to relay transmissions from nodes to other nodes. It would be beneficial if the beginning of portion 102 would be allowed to vary based on an amount of data in portion 101, however, the node receiving the relayed data cannot be synchronized with the relay node if the starting time of the preamble is changed. Therefore, a need exists for a method and apparatus for transmitting data within a multi-hop communication system that is more efficient that prior-art techniques.

### BRIEF DESCRIPTION OF THE DRAWINGS

FIG. 1 is a block diagram of a prior-art frame structure.

FIG. 2 is a block diagram of a communication system.

FIG. 3 illustrates a frame.

FIG. 4 is a block diagram of a node.

FIG. 5 is a flow chart showing operation of the node of FIG. 4 when serving as a base station.

FIG. 6 is a flow chart showing operation of the node of FIG. 4 when serving as a relay node.

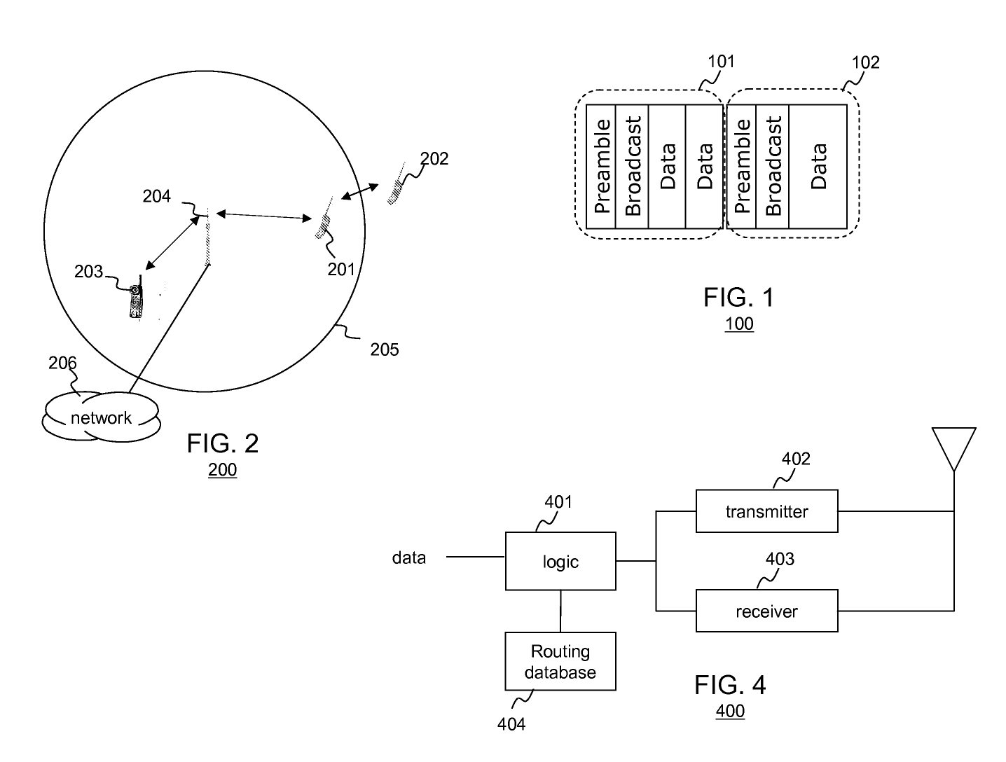

### DETAILED DESCRIPTION OF THE DRAWINGS

In order to address the above-mentioned need, a method and apparatus for relaying data within a multi-hop communication system is provided herein. During operation, all preamble and broadcast information for relaying nodes and for the base station is placed during a beginning portion of a frame prior to any data transmission. By placing preamble/broadcast portions in the beginning of the frame, the data transmission portions of the frame can be allowed to vary in time, yet synchronization will be allowed between all nodes in the system.

The present invention encompasses a method for transmitting data from a base station within a multi-hop communication system. The method comprises the steps of receiving data from a network that is to be relayed to a node, determining route information for the data, and determining a size of a transmission for the data. A preamble is transmitted during a first portion of a frame so that a relay node may synchronize with the base station, and broadcast information is transmitted during the first portion of the frame indicating when the data will be transmitted, which causes the relay node to transmit its own broadcast information during the first portion of the frame. Finally, the data is transmitted to the relay node during the second portion of the frame, causing the relay node to relay the data during the second portion of the frame.

The present invention additionally encompasses a method for a first node to relay data within a multi-hop communication system. The method comprises the steps of receiving a preamble transmission from a base station during a first portion of a frame, synchronizing to the preamble transmission, and receiving a broadcast transmission from the base station during the first portion of the frame indicating that data should be relayed to a second node. A second preamble is transmitted during the first portion of the frame along with a second broadcast transmission. The data is received from the base station during a second portion of the frame and relayed to a second node during the second portion of the frame.

The present invention additionally encompasses an apparatus comprising a receiver receiving a preamble transmission from a base station during a first portion of a frame, receiving a broadcast transmission from the base station indicating that data should be relayed to a second node during the first portion of the frame, and receiving the data from the base station during a second portion of the frame. The receiver additionally comprises transmission circuitry transmitting a second preamble during the first portion of the frame, transmitting a second broadcast transmission during the first portion of the frame, and relaying the data to a second node during the second portion of the frame.

Turning now to the drawings, wherein like numerals designate like components, FIG. 2 is a block diagram of communication system 200. Communication system 200 comprises a plurality of cells 205 (only one shown) each having a base transceiver station (BTS, or base station) 204 in communication with a plurality of remote, or mobile nodes 201-203. In the preferred embodiment of the present invention, communication system 200 utilizes a next generation Orthogonal Frequency Division Multiplexed (OFDM) or multicarrier based architecture. Preferably, communication system 200 utilizes an IEEE 802.16 communication system protocol, however, in alternate embodiments communication system 200 may utilize other wideband cellular communication system protocols such as, but not limited to, TDMA or direct sequence CDMA. Finally, network 206 may comprise any local, or wide-area network as is commonly known in the art.

As shown, during operation base station 204 receives data from network 206 destined to a node (e.g., node 202). As is evident node 202 is outside the transmission range of base station 204. When this occurs, node 202 may receive its transmissions from base station 204 through intervening node 201. Thus, base station 204 will transmit data to node 201, with node 201 eventually transmitting the data to node 202. As discussed above, in order to more efficiently relay data among nodes, preamble and broadcast information within a frame are separated from data transmissions within the frame. Thus, during the portion of the frame having data transmissions, no preamble, pilot, or broadcast data is sent. This is illustrated in FIG. 3.

During operation all nodes 201-203 along with base station 204 will transmit a preamble, broadcast information, and data. Preamble information (as defined in IEEE 802.16 section 8.3.3.6, 8.4.4, 8.4.6.1) comprises a known sequence transmitted at known time intervals and frame duration. A receiver, knowing the sequence only or knowing the sequence and time interval in advance, utilizes this information to perform timing adjustments. Broadcast information (as defined in IEEE 802.16 sections 6.3.2.3.1-6.3.2.3.4 and 8.3.6, 8.4.4, 8.4.5) instructs all listening devices as to when a particular node 201-204 will be transmitting data. As is evident in FIG. 3, node 201 and 204 (base station and intervening node) will transmit their preamble and broadcast information during a first portion 315 of a downlink subframe, with their data being transmitted in a second portion 317 of the downlink subframe. Thus, for example, base station 204 will transmit preamble 301, broadcast 303, data 309, and data 311. Broadcast 303 instructs nodes 201 and 203 as to when their data will be transmitted by base station 204. In a similar manner, since node 201 will be relaying data, it (and all nodes relaying data) will transmit preamble 305, broadcast information 307, and relayed data 313. In this example, data 309 is destined for node 203 while data 311 is destined to node 201, a portion or all of data 311 will then be relayed to node 202 as data 313.

As discussed above, by placing preamble/broadcast portions in the beginning of the frame, the data transmission portions of the frame can be allowed to vary in time, yet synchronization will be allowed between all nodes in the system. Thus, data 309, data 311, and data 313 may not be equal in size, but can vary depending on an amount of data to be transmitted.

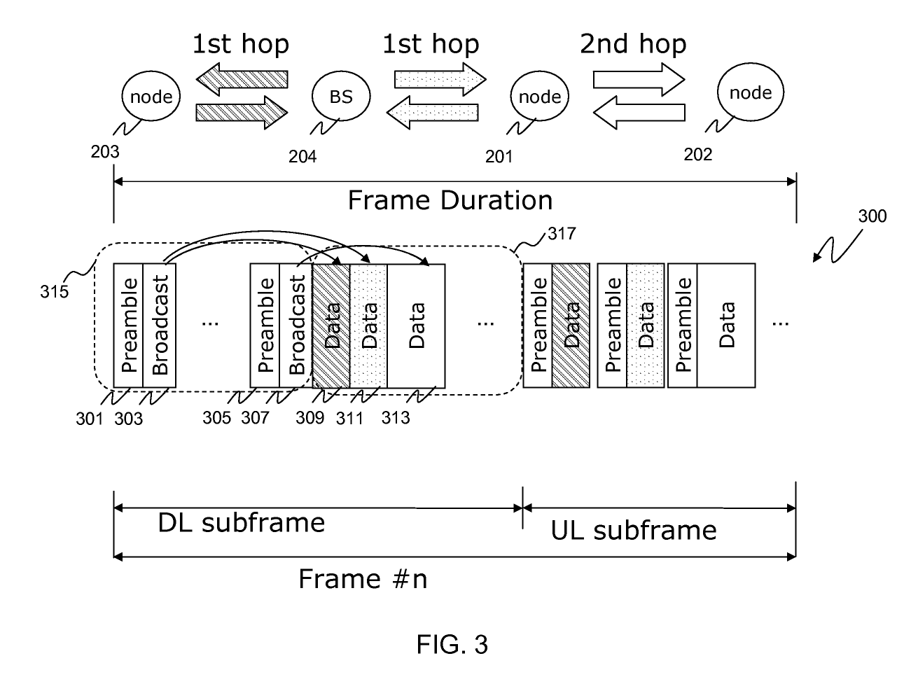

FIG. 4 is a block diagram of node 400 used to transmit information as shown in FIG. 3. As shown, node 400 comprises logic circuitry 401, transmit circuitry 402, receive circuitry 403, and database 404. Logic circuitry 401 preferably comprises a microprocessor controller, such as, but not limited to a Freescale PowerPC microprocessor. Database 404 comprises standard random access memory and serves to store routing information such as node addresses and intervening nodes. Quality of service information is also stored in database 404. Transmit and receive circuitry 402-403 are common circuitry known in the art for communication utilizing a well known network protocols, and serve as means for transmitting and receiving messages. For example, transmitter 402 and receiver 403 are preferably well known transmitters and receivers that utilize an IEEE 802.16 network protocol. Other possible transmitters and receivers include, but are not limited to transceivers utilizing Bluetooth, 3GPP, or HyperLAN protocols.

During operation, transmitter 402 and receiver 403 transmit and receive data and control information as discussed above. More particularly, data transmission takes place by receiving data to be transmitted over a radio frame. The radio frame (shown in FIG. 3) is comprised of a plurality of subframes, with each subframe comprising either downlink transmissions or uplink transmissions. During transmission, logic circuitry 401 selects a position within the frame for preamble, broadcast, and data transmissions. This is determined by incoming data from base station 204. Logic circuitry 401 routes the incoming data to destinations such as node 202 and node 203. According to the route information and preference of communication quality collected in advance, the structure of the downlink subframe is determined. For example, because data for node 202 is transmitted via node 201, node 204 reserves radio resources for node 201 after a preamble and broadcast are transmitted from node 204. Then node 204 includes messages in the broadcast messages such that node 201 transmits preamble and broadcast during the reserved radio resource. The time to transmit the preamble from node 201 is decided by node 204 such that node 201 has enough time to switch from a receive mode (listening for preamble and broadcasts from node 204) to transmit mode (transmitting preamble and broadcast to node 202). The length of the broadcast message that is transmitted from node 204 is dependent on a number of nodes that communicate with node 204. If node 204 communicates with many nodes, the length of the broadcast message is also long. The length of the broadcast message would be decided considering maximum number of nodes that communicates with node 204. Based on the positions within the frame for transmitting preamble, broadcast information, and data, logic circuitry 401 instructs transmitter 402 to appropriately transmit the information.

If node 400 is acting as a relay station, a logic circuitry 401 will instruct receiver 403 to retrieve transmitted data at an appropriate time period which was determined by analyzing broadcast transmission 303 transmitted from base station 204. Once the data has been received, logic circuitry 401 will instruct transmitter 402 to relay a portion or all of the received data. The relaying of data will occur by informing a node of a pending transmission in a broadcast message, and transmitting the data at the appropriate time period.

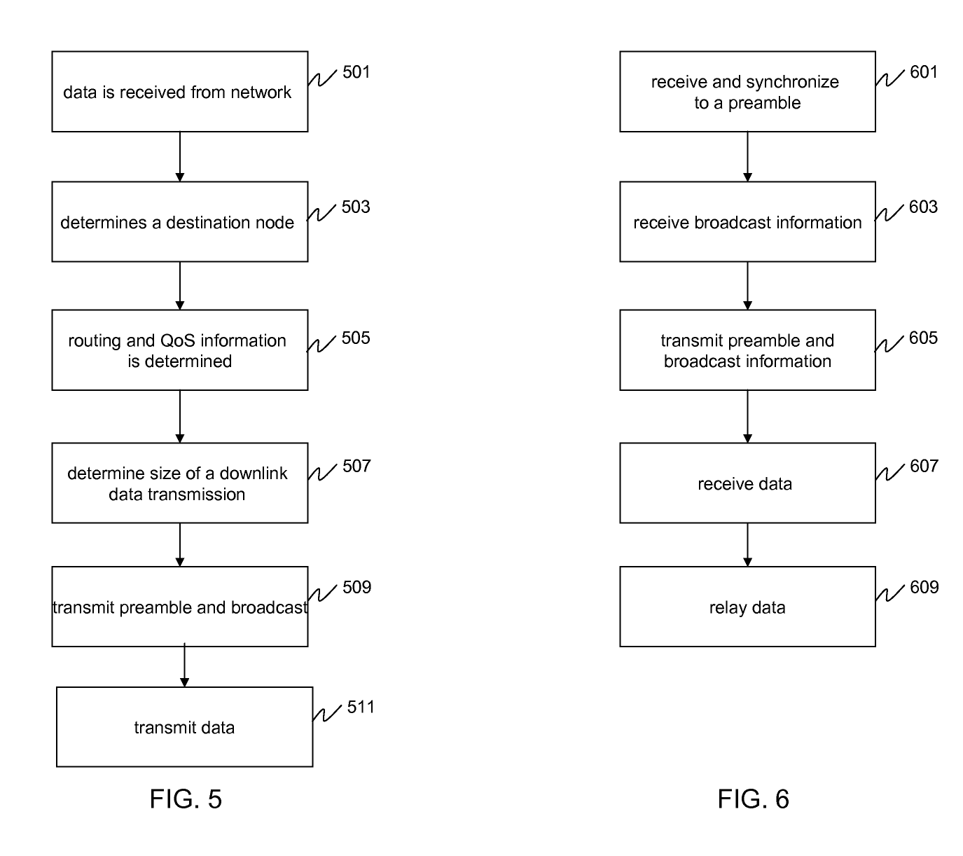

FIG. 5 is a flow chart showing operation of node 400 when serving as a base station. The logic flow begins at step 501 where data is received from network 406. The data is to be relayed to a node within communication system 100. Logic circuitry 401 analyzes the data and determines a destination node (step 503). At step 505, routing information is determined by logic circuitry 401 accessing database 404 to determine a route to the destination node, and any intervening nodes. Additionally, at step 505, quality-of-service (QoS) information is determined from routing database 404. A size of a downlink data transmission (e.g., an amount of data to transmit to the destination node within a particular sub-frame) is determined preferably, but not necessarily based on the QoS (step 507). The step of determining the size of transmission for the data comprises determining how many milliseconds or OFDM symbols that data is to be transmitted. A preamble and a broadcast is then transmitted by transmitter 403 (step 509) during the first portion of the frame indicating when the data will be transmitted, which causes the relay node to transmit its own broadcast information during the first portion of the frame. Finally data is transmitted during the second portion of the frame causing the relay node to relay at least a portion of the data during the second portion of the frame (step 511).

As discussed above, all preamble and broadcast information for relaying nodes and for the base station is placed during a beginning portion of a frame prior to any data transmission. By placing all preamble/broadcast portions in the beginning of the frame, the data transmission portions of the frame can be allowed to vary in time, yet synchronization will be allowed between all nodes in the system. Thus, in accordance with the present invention, all preamble and broadcast information for the relay node and for the base station is placed during a same beginning portion of a single frame prior to any data transmission and any relay transmission. Both the data transmission and the relay transmission take place during a second portion of a same or differing frame.

FIG. 6 is a flow chart showing operation of node 400 when serving as an intervening node. The logic flow begins at step 601 where receiver 403 receives and synchronizes to a preamble broadcast from base station 104. As discussed above, the preamble is received during a first portion of a frame. At step 603 broadcast information is received from base station 104 during the first portion of the frame. As discussed above, the broadcast information comprises information regarding what data should be relayed and when the data is to be relayed. At step 605 transmitter 402 transmits its own preamble and broadcast information during the first portion of the frame. As discussed above, all preamble and broadcast information for all relaying nodes and for the base station is placed during a beginning portion of a frame prior to any data transmission. Data is then received by receiver 402 during a second portion of the frame(step 607) and is relayed to the destination node (step 609) during the second portion of the frame. By placing all preamble/broadcast portions in the beginning of the frame, the data transmission portions of the frame can be allowed to vary in time, yet synchronization will be allowed between all nodes in the system.

Thus, in accordance with an embodiment of the present invention receiver 403 receives a preamble transmission from a base station during a first portion of a frame, receives a broadcast transmission from the base station indicating that data should be relayed to a second node during the first portion of the frame, and receives the data from the base station during a second portion of the frame. In a similar manner, transmitter 402 transmits a second preamble during the first portion of the frame, transmits a second broadcast transmission during the first portion of the frame, and relays the data to a second node during the second portion of the frame.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for transmitting data from a base station within a multi-hop communication system, the method comprising the steps of:
receiving data from a network that is to be relayed to a node;
determining route information for the data;
determining a size of a transmission for the data;
transmitting a preamble during a first portion of a frame so that a relay node may synchronize with the base station;
transmitting broadcast information during the first portion of the frame indicating when the data will be transmitted, which causes the relay node to transmit its own broadcast information during the first portion of the frame; and
transmitting the data to the relay node during the second portion of the frame, causing the relay node to relay the data during the second portion of the frame;

2. The method of claim 1 wherein the preamble comprises a known sequence transmitted at known time intervals and frame duration.

3. The method of claim 1 wherein the step of determining the size of transmission for the data comprises the step of determining how many milliseconds or OFDM symbols for data transmissions.

4. The method of claim 1 wherein the step of determining the size of transmission for the data comprises the step of determining Quality of Service information for the data and determining the size of the transmission based on the Quality of Service information.

5. A method for a first node to relay data within a multi-hop communication system, the method comprising the steps of:
receiving a preamble transmission from a base station during a first portion of a frame;
synchronizing to the preamble transmission;
receiving a broadcast transmission from the base station during the first portion of the frame indicating that data should be relayed to a second node;
transmitting a second preamble during the first portion of the frame;
transmitting a second broadcast transmission during the first portion of the frame;
receiving the data from the base station during a second portion of the frame; and
relaying the data to a second node during the second portion of the frame.

6. The method of claim 4 wherein the preamble transmission comprises a known sequence transmitted at known time intervals and frame duration.

7. The method of claim 4 wherein the broadcast transmission instructs all listening devices as to when a particular node will be transmitting data.

8. An apparatus comprising:
a receiver receiving a preamble transmission from a base station during a first portion of a frame, receiving a broadcast transmission from the base station indicating that data should be relayed to a second node during the first portion of the frame, and receiving the data from the base station during a second portion of the frame; and
transmission circuitry transmitting a second preamble during the first portion of the frame, transmitting a second broadcast transmission during the first portion of the frame, and relaying the data to a second node during the second portion of the frame.

9. The apparatus of claim 8 wherein the preamble transmissions comprise a known sequence transmitted at known time intervals and frame duration.

10. The apparatus of claim 8 wherein the broadcast transmissions instructs all listening devices as to when a particular node will be transmitting data.
